(19) United States
(12) Patent Application Publication
(10) Pub. No.: US 2009/0028057 A1
(43) Pub. Date: Jan. 29, 2009

(54) NETWORK DELAY MEASUREMENT METHOD AND COMMUNICATION SYSTEM

(75) Inventors: Sumiyo OKADA, Kawasaki (JP); Noriyuki Fukuyama, Kawasaki (JP); Masanobu Morinaga, Kawasaki (JP); Hideaki Miyazaki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kanagawa (JP)

(21) Appl. No.: 12/179,964

(22) Filed: Jul. 25, 2008

(30) Foreign Application Priority Data
Jul. 27, 2007 (JP) 2007-196604

(51) Int. Cl. H04L 12/26; H04L 1/00

(52) U.S. Cl. 370/242; 370/252

(57) ABSTRACT

A measurement method and communication system include a writing of a creation time upon a detection packet used for detecting a communication state of a network being created into the detection packet. The method includes obtaining a send time when the detection packet was sent and sending, to a receiving apparatus which receives the detection packet, as a notification, information regarding a time period from when the detection packet was created to when the detection packet was sent. The method includes measuring, in the receiving apparatus, a delay occurring in the network based on the detection packet and the information sent as the notification.

### CROSS-REFERENCE TO RELATED APPLICATIONS

This application is related to and claims priority to Japanese Patent Application No. 2007-196604 filed on Jul. 27, 2007 in the Japanese Patent Office, and incorporated by reference herein.

### BACKGROUND

1. Field

The embodiments discussed herein are directed to a technology for detecting a communication state of a communication path in a network.

2. Description of the Related Art

Use of communication systems such as internet protocol (IP) telephony systems using an IP network (a packet communication network), for example, a voice over internet protocol (VoIP), have been becoming widespread. In a communication system using an IP network, in order to maintain communication quality, it is important to know a communication state in advance and with high accuracy in a case in which there is an increased network load.

A method of measuring a delay time and jitter characteristics, as a method of detecting a communication state of a communication path, by utilizing an actual in-service network has been disclosed. According to the method, when a measurement packet is sent, time-stamp information is inserted into the measurement packet. By transmitting the measurement packet inside a measurement area of the network, a transmission delay time is measured.

FIG. 1 illustrates a network delay measured in an example.

As illustrated illustrated in FIG. 1, a transmission delay time measured can be defined as a “time period from the time when a measurement packet was created to the time when the measurement packet was received by a receiving apparatus.”

In a case in which a network delay is measured by a conventional method, if a sending apparatus is a low-priced appliance such as a personal computer (PC), a delay can occur in the sending apparatus.

That is, a time period including a delay occurring in a central processing unit (CPU) and in processing of an operating system (OS) of the PC can be measured as the transmission delay time.

In the above-described network delay measurement method, the “delay occurring in the network” and the “delay occurring in the sending apparatus” cannot be separated. Thus, there is a disadvantage that the measurement of only the delay occurring in the network which needs to be measured separately from the delay occurring in the sending apparatus cannot be precisely performed.

### SUMMARY

It is an aspect of the embodiments discussed herein to provide a measurement method including writing a creation time upon a detection packet used for detecting a communication state of a network being created into the detection packet, obtaining a send time upon the detection packet being sent, sending, to a receiving apparatus which receives the detection packet, as a notification, information regarding a time period from upon the detection packet was created to when the detection packet was sent, and measuring, in the receiving apparatus, a delay occurring in the network based on the detection packet and the information sent as the notification.

It is an aspect of the embodiments discussed herein to provide a sending apparatus which sends a detection packet to obtain a time when the detection packet was sent into the network. For the send time to be recognized in the receiving apparatus which receives the detection packet, necessary information can be sent to the receiving apparatus as a notification. In the receiving apparatus, using the information sent as the notification, a transmission time delay, which does not include a delay (a time period from when the detection packet was created to when it was sent) caused by processing performed inside the sending apparatus, that is, a delay occurring in the network can be measured.

The information sent to the receiving apparatus as the notification can include the send time when the detection packet was sent or a difference between a creation time when the detection packet was created and the send time. In the measuring the network delay, the delay occurring in the network can be calculated, using the send time or the difference, by calculating a time period from when the detection packet was sent to when the detection packet was received.

The information sent to the receiving apparatus as the notification may be written into a detection packet subsequent to the detection packet.

Alternatively, the information sent to the receiving apparatus as the notification may be stored in a file.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates a method of measuring network delay;

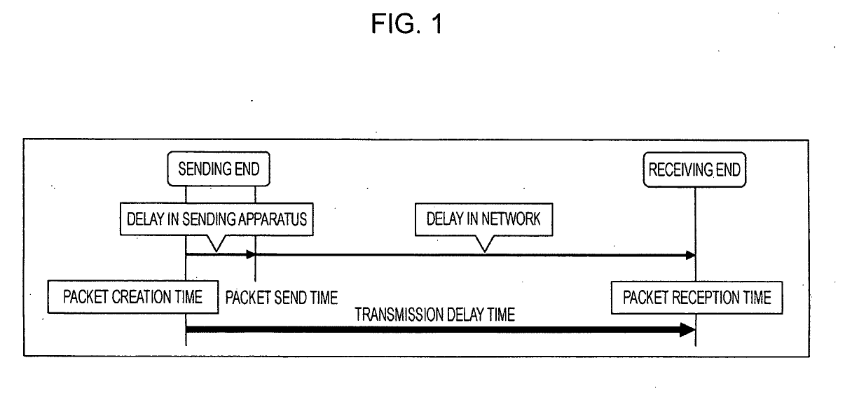

FIG. 2 illustrates a network delay;

FIG. 3 illustrates a method of measuring a network delay;

FIG. 4 illustrates a network delay measurement method according to an example embodiment;

FIG. 5 illustrates a network delay measurement method according to an example embodiment;

FIG. 6 illustrates a network delay measurement method according to an example embodiment; and

FIG. 7 illustrates a network delay measurement method according to an example embodiment.

### DETAILED DESCRIPTION OF THE EMBODIMENTS

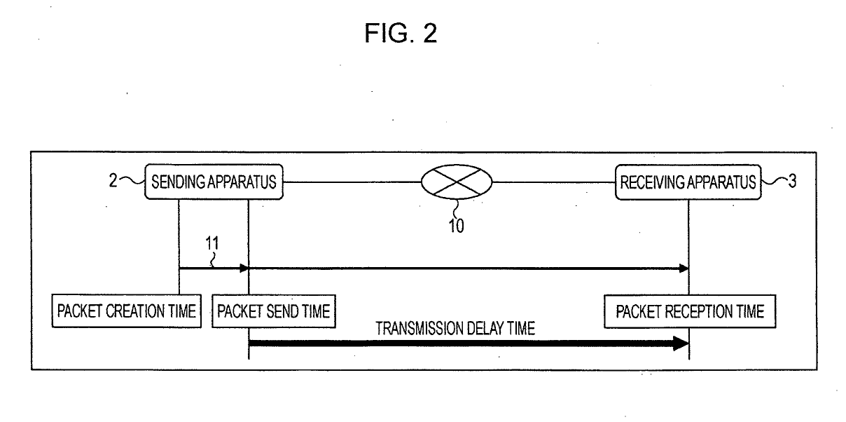

FIG. 2 illustrates a network delay in an example embodiment.

Between two apparatuses connected to each other via an IP network (a packet communication network) 10 (hereinafter simply referred to as a network 10), a detection packet can be sent from an apparatus to another apparatus, and a communication state of the network 10 is detected.

In a system configuration illustrated in FIG. 2, an apparatus that sends a detection packet is a sending apparatus 2, and an apparatus that receives the detection packet is a receiving apparatus 3.

The sending apparatus 2 obtains a time when a detection packet was sent into the network 10, that is, a time when a detection packet was sent from the sending apparatus 2 to the receiving apparatus 3, which is a destination of the detection packet. Then, the sending apparatus 2 sends, as a notification, information to the receiving apparatus 3, the information being used in the receiving apparatus 3 to distinguish a delay 11 occurring in the sending apparatus 2 from a delay occurring in the network 10.

Based on the information received from the sending apparatus 2, the receiving apparatus 3 calculates a time period (a network delay) needed to transmit the detection packet with consideration of the delay 11 occurring inside the sending apparatus 2.

In the following, a delay time required from when a detection packet was created in the sending apparatus 2 to when it was sent into the network 10 can be defined as an “in-apparatus delay”, which is distinguished from the delay occurring in the network 10.

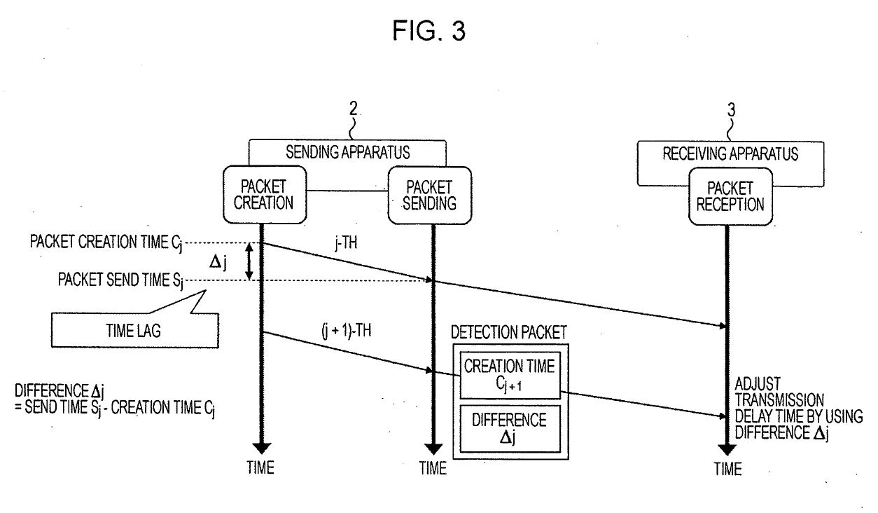

FIG. 3 illustrates a method of measuring a network delay.

In the sending apparatus 2 in which a detection packet is created, a time when a detection packet was created (a creation time Cⱼ) is written into, for example, the payload of the detection packet.

In the receiving apparatus 3, when the detection packet is received, a time period from when the packet was sent from the sending apparatus 2 to when it was received by the receiving apparatus 3 can be measured as the network delay.

Here, an example of the related art is utilized as processing used to write the creation time Cⱼ of the detection packet into the payload.

When the sending apparatus 2 sends detection packets to the receiving apparatus 3, which is a destination of the detection packets, the sending apparatus 2 obtains, for each of the detection packets, the time when the detection packet was sent into the network 10.

The sending apparatus 2 sends, to the receiving apparatus 3, as a notification, information regarding the time period from when the detection packet was created to when the detection packet was sent, that is, the in-apparatus delay (a time lag) or a send time of the detection packet.

FIG. 3 illustrates a case in which information regarding the in-apparatus delay can be sent as a notification, that is, a case in which information regarding the difference Δj between the creation time Cⱼ and a send time Sⱼ is sent as a notification. The receiving apparatus 3 can calculate a network delay using the information sent as a notification from the sending apparatus 2.

Here, the send time Sⱼ of the detection packet (or the difference Δj calculated using the send time Sⱼ) cannot be sent by being included in the detection packet to be sent.

Thus, such information indicating the time lag (time-lag information) may be independently sent to the receiving apparatus 3 as a notification after the detection packet has been sent into the network 10.

In the following, a method of measuring a network delay based on the information sent from the sending apparatus 2 to the receiving apparatus 3 as a notification is described.

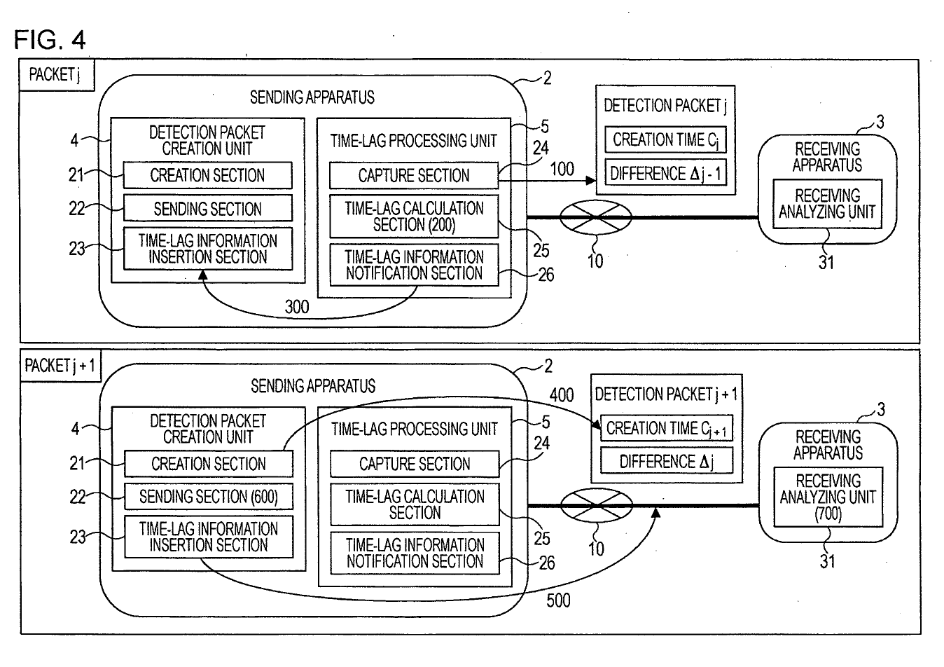

FIG. 4 illustrates a network delay measurement method according to an example embodiment. The sending apparatus 2 and the receiving apparatus 3 can be connected to each other via the network 10.

The sending apparatus 2 illustrated in FIG. 4 includes a detection packet creation unit 4 and a time-lag processing unit 5. The detection packet creation unit 4 includes a creation section 21, a sending section 22, and a time-lag information insertion section 23. The time-lag processing unit 5 includes a capture section 24, a time-lag calculation section 25, and a time-lag information notification section 26.

The creation section 21 of the detection packet creation unit 4 creates a detection packet. The sending section 22 sends the detection packet to the receiving apparatus 3, which is a destination of the detection packet.

The time-lag information insertion section 23 inserts information necessary to calculate an in-apparatus delay in the receiving apparatus 3 into the payload of a subsequent detection packet.

In an example shown in FIG. 4, the difference Δj between the creation time Cⱼ and send time Sⱼ of the j-th detection packet (hereinafter referred to as a “detection packet (j)”) may be inserted into the payload of a subsequent detection packet, which is a detection packet (j+1) in the example illustrated in FIG. 4.

The capture section 24 of the time-lag processing unit 5 obtains the send time Sⱼ of the detection packet.

The time-lag calculation section 25 calculates the difference Δj between the creation time Cⱼ and send time Sⱼ of the detection packet (j).

The time-lag information notification section 26 sends, to the detection packet creation unit 4, as a notification, the difference Δj which has been calculated by the time-lag calculation section 25.

The receiving apparatus 3 includes a receiving analyzing unit 31. The receiving analyzing unit 31 of the receiving apparatus 3 calculates the in-apparatus delay based on the j-th detection packet and the difference Δj extracted from the (j+1)-th detection packet, which are received from the sending apparatus 2.

The network delay may be measured by using the extracted difference Δj, the creation time Cⱼ written into the payload of the detection packet (j), and a time when the detection packet was received.

Operations used to calculate a network delay in a configuration illustrated in FIG. 4 will be described. The operations are denoted by numerals in FIG. 4.

Here, before a series of processes are executed, it is assumed that the detection packet (j) has been created and the packet creation time Cⱼ has been inserted into the payload of the detection packet (j).

In operation 100, the capture section 24 obtains the time Sⱼ when the detection packet (j) was sent from the sending apparatus 2 into the network 10. The capture section 24 may be realized by, for example, an application of a PC.

When the receiving analyzing unit 31 of the receiving apparatus 3 receives the detection packet (j), the receiving analyzing unit 31 obtains the reception time, and extracts the creation time Cⱼ of the detection packet (j) from the payload thereof.

Next, in operation 200, the time-lag calculation section 25 calculates the difference Δj between the obtained send time Sⱼ and the creation time Cⱼ of the detection packet (j), that is, the difference Δj=Sⱼ−Cⱼ.

In operation 300, the time-lag information notification section 26 sends, as a notification, the difference Δⱼ to the time-lag information insertion section 23 of the detection packet creation unit 4.

In operation 400, the sending apparatus 2 stores, in the payload of a detection packet (j+1) which will be sent next, a creation time Cⱼ₊₁ of the detection packet (j+1). In operation 500, the difference Δj can be inserted into the payload of the detection packet (j+1). In operation 600, the detection packet (j+1) is sent.

Here, FIG. 4 illustrates a operation of sending, as a notification, the difference Δj of the detection packet (j) to the receiving apparatus 3. Although a description for the detection packet (j+1) is omitted, the send time Sⱼ₊₁ is obtained by the capture section 24 and the difference Δ(j+1) is calculated, similarly to the detection packet (j). A creation time Cⱼ₊₂ and the difference Δ(j+1) are inserted into the payload of a packet which is to be sent next (a detection packet (j+2)).

In operation 700, the receiving apparatus 3 extracts the difference Δj from the payload of the detection packet (j+1), and calculates a transmission delay time using the difference Δj, the creation time Cⱼ, and the time when the detection packet (j) was received by the receiving apparatus 3.

FIG. 4 illustrates a configuration in which the difference Δj of the detection packet (j) may be sent by being inserted into the detection packet (j+1) which will be sent next; however, the configuration is not limited thereto.

The configuration may be a configuration in which the difference Δj may be sent by being inserted into an arbitrary detection packet to be sent and subsequent to the detection packet (j), that is, a detection packet whose packet number is larger than or equal to j+1.

Furthermore, the configuration may be a configuration described below. In the configuration, differences Δj, Δ(j+1), Δ(j+2), and the like are obtained in advance for respective detection packets, and a plurality of pieces of difference information (Δj, Δ(j+1), Δ(j+2), and the like) are sent by being collectively inserted into a detection packet to be sent and subsequent to the detection packets whose differences have been obtained.

In a case in which a plurality of pieces of difference information are collectively sent, as long as all pieces of the difference information are received by a receiving apparatus, the configuration may be a configuration which allows the difference of a detection packet to be sent a plurality of times redundantly.

As described above, according to the network delay measurement method according to an example embodiment, the send time of the detection packet is obtained, and the difference between the send time and the creation time of the detection packet, that is, the difference information representing a time required from when the detection packet was created to when it was sent into the network is inserted into a subsequent detection packet.

In the receiving apparatus in which the network delay is measured, a time period, that is, the network delay (the transmission delay time) can be obtained by subtracting “the time period represented by the difference information extracted from the subsequent detection packet (the in-apparatus delay)” from “the time period from when the detection packet was created to when it was received by the receiving apparatus”.

Even in a system configuration in which a low-priced apparatus such as a PC may be used as a terminal of the network and which causes an in-apparatus delay to be relatively large, the delay occurring in the network can be more precisely obtained with consideration of the in-apparatus delay.

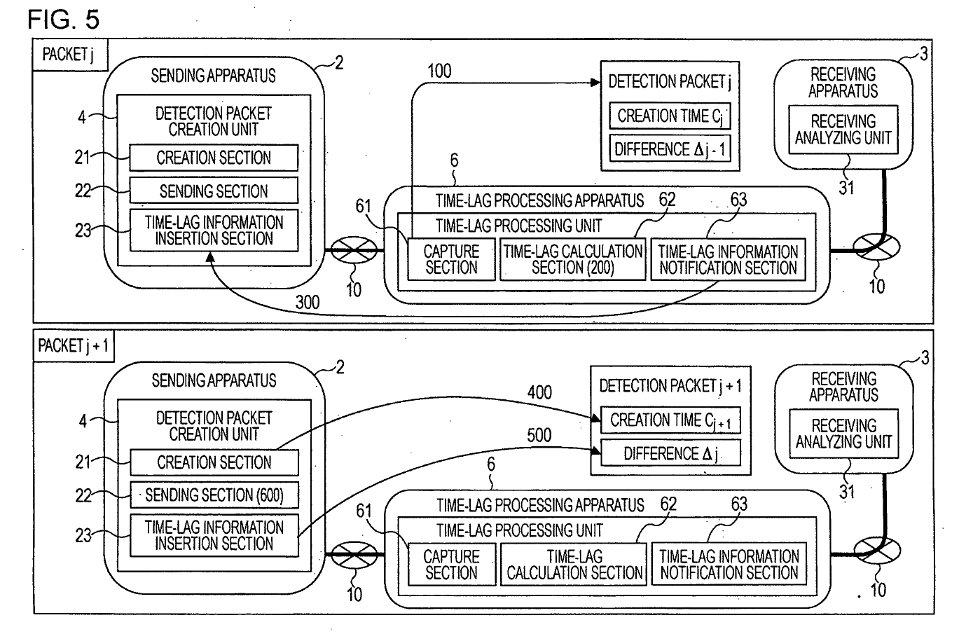

FIG. 5 illustrates a network delay measurement method according to an example embodiment. The processing of capturing a send time, and processing of calculating and sending, as the notification, the difference Δj are performed by a time-lag processing apparatus which may be different from the sending apparatus 2.

A communication system illustrated in FIG. 5 includes the sending apparatus 2, the receiving apparatus 3, and a time-lag processing apparatus 6. The sending apparatus 2 and the receiving apparatus 3 are connected to each other via the network 10.

The time-lag processing apparatus 6 illustrated in FIG. 5 can be located between the sending apparatus 2 and the receiving apparatus 3, and includes a capture section 61, a time-lag calculation section 62, and a time-lag information notification section 63. The sections of the time-lag processing apparatus 6 operate similarly to corresponding sections illustrated in FIG. 4. The differences from the operations illustrated in FIG. 4 will be described below.

In operation 100, the time-lag processing apparatus 6 which may be used to process a time lag obtains the send time Sⱼ of the detection packet (j). In operation 200, the difference Δj(=the send time Sⱼ−the creation time Cⱼ) may be calculated. In operation 300, the obtained difference Δj may be sent, as the notification, to the sending apparatus 2.

Operation 400 and thereafter in the second example embodiment are similar to operation 400 and thereafter in the first example embodiment. In the sending apparatus 2, the difference Δj which has been sent as a notification from the time-lag processing apparatus 6 may be inserted into the payload of the subsequent detection packet (the detection packet (j+1) in FIG. 5).

The receiving apparatus 3 extracts the difference Δj from the detection packet (j+1), and calculates a transmission delay time of the detection packet (j).

With respect to the network delay measurement method according to the second example embodiment, similarly to the first example embodiment, a time at which the difference Δj is sent to the receiving apparatus 3 is not limited to a time when the next detection packet (j+1) is sent. The difference Δj may be sent by being inserted into a subsequent detection packet to be sent.

Moreover, the configuration for the second example embodiment may be a configuration in which, with respect to a plurality of detection packets, differences are obtained for the respective detection packets and are sent by being collectively inserted into a subsequent detection packet to be sent.

As illustrated in FIG. 5, even in a case in which the configuration includes the time-lag processing apparatus 6, which may be different from the sending apparatus 2, the network delay can similarly be measured with consideration of the in-apparatus delay.

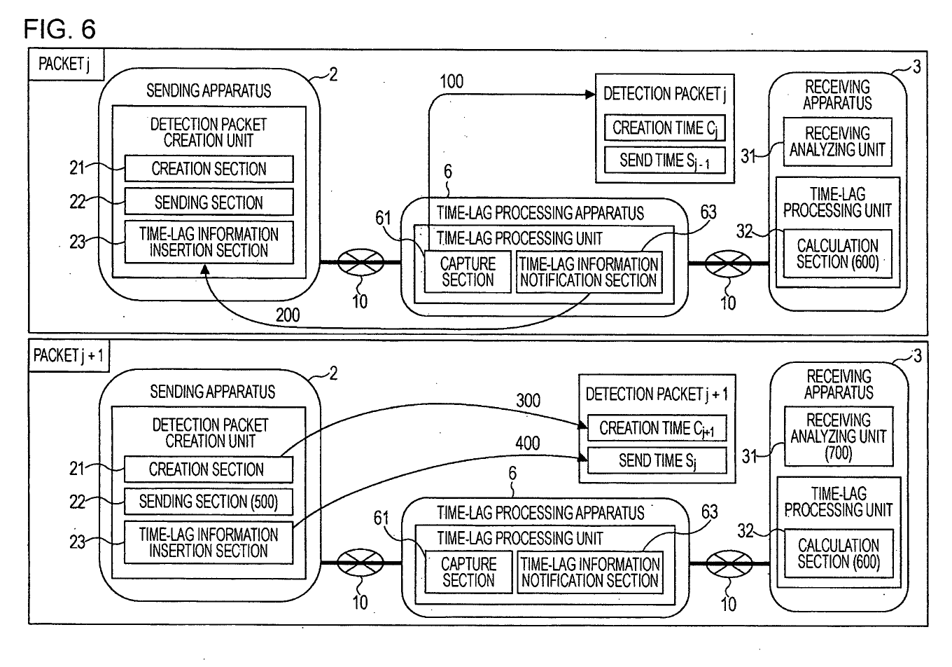

FIG. 6 illustrates a network delay measurement method according to an example embodiment. The t send time Sⱼ which has been obtained is sent as a notification to the receiving apparatus 3 instead of the difference Δj between the creation time Cⱼ and the send time Sⱼ.

A communication system illustrated in FIG. 6 includes the sending apparatus 2, the receiving apparatus 3, and the time-lag processing apparatus 6. The sending apparatus 2 and the receiving apparatus 3 are connected to each other via the network 10. The structure of the sending apparatus 2 is similar to that illustrated in FIG. 5. Thus, the description thereof is omitted.

The time-lag processing apparatus 6 includes the capture section 61 and the time-lag information notification section 63. The capture section 61 operates similarly to that in the time-lag processing apparatus according to the second example embodiment. The time-lag information notification section 63 sends, to the sending apparatus 2, the obtained send time Sⱼ of the detection packet as a notification.

The receiving apparatus 3 includes a calculation section 32 in addition to the receiving analyzing unit 31.

Here, FIG. 6 illustrates a configuration in which time-lag information, that is, the send time Sⱼ of the detection packet is obtained by an apparatus (the time-lag processing apparatus 6) different from the sending apparatus 2; however, the configuration is not limited thereto. The sending apparatus 2 may be configured to obtain the send time Sⱼ.

In operations illustrated in FIG. 6, in operation 100, the capture section 61 of the time-lag processing apparatus 6 obtains the send time Sⱼ of the detection packet (j), similarly to operation 100 of FIG. 5. In operation 200, the time-lag processing apparatus 6 sends, as a notification, the obtained send time Sⱼ to the sending apparatus 2.

In operation 300, with respect to the detection packet (j+1), the sending apparatus 2 inserts the creation time Cⱼ₊₁ of the detection packet (j+1) into the payload of the detection packet (j+1). In operation 400, the send time Sⱼ of the detection packet (j) is inserted into the payload of the detection packet (j+1). Then, in operation 500, the detection packet (j+1) may be sent.

In operation 600, the calculation section 32 of the receiving apparatus 3 receives the detection packet (j+1) and extracts the send time Sⱼ of the detection packet (j) from the payload of the detection packet (j+1). In operation 700, a transmission delay time may be calculated using the difference Δj obtained using the send time Sⱼ extracted from the detection packet (j+1) and the creation time Cⱼ extracted from the detection packet (j), and the time when the detection packet (j) was received by the receiving apparatus 3.

Here, a transmission delay time which does not include the in-apparatus delay (the delay occurring in the network) can be calculated using the reception time when the detection packet was received by the receiving apparatus 3 and the send time Sⱼ. Thus, in FIG. 6, after the difference Δj may be calculated by the calculation section 32, the transmission delay time is calculated; however, the processing of obtaining this difference Δj is not essential.

Moreover, in an example illustrated in FIG. 6, the creation time Cⱼ of the detection packet (j) is inserted into the payload of the detection packet (j); however, as described above, this is not information essential to calculate the transmission delay time with consideration of the in-apparatus delay.

In the network delay measurement method according to a third example embodiment, a configuration is used in which the send time Sⱼ is sent by being Inserted into the next subsequent detection packet (j+1) to be sent; however, the configuration is not limited thereto. The send time Sⱼ may be sent by being inserted into an arbitrary detection packet to be sent as long as the arbitrary detection packet is a detection packet subsequent to the detection packet (j).

Furthermore, the configuration for the third example embodiment may be a configuration in which, with respect to a plurality of detection packets, send times Sⱼ, Sⱼ₊₁, Sⱼ₊₂, and the like are obtained for the respective detection packets and the send times are sent by being collectively inserted into a subsequent detection packet to be sent.

As described above, according to the network delay measurement method according to the third example embodiment, send time Information of a detection packet is inserted into a subsequent detection packet. In the receiving apparatus, the send time information is extracted from the subsequent detection packet, and the transmission delay time which does not include the in-apparatus delay, that is, the delay occurring in the network can be more precisely obtained.

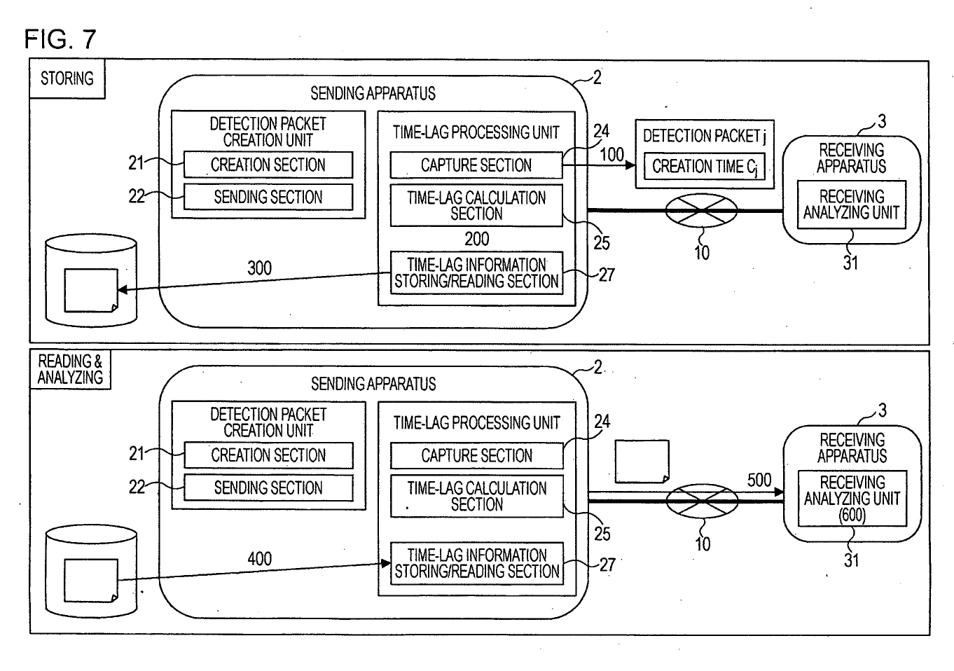

FIG. 7 illustrates a network delay measurement method according to an example embodiment. The network delay measurement method according to the fourth example embodiment differs from the network delay measurement methods according to the first to the third example embodiments in that time-lag information is stored in a file and the file is sent to the receiving apparatus 3.

The sending apparatus 2 illustrated in FIG. 7 includes the creation section 21, the sending section 22, the capture section 24, the time-lag calculation section 25, and a time-lag information storing/reading section 27. The sending apparatus 2 can be structurally similar to the sending apparatus 2 illustrated in FIG. 3 except for the time-lag information storing/reading section 27.

The time-lag information storing/reading section 27 writes the difference Δj which has been obtained by the time-lag calculation section 25 into a predetermined file. The time-lag information storing/reading section 27 reads the file at a predetermined time, and transfers it to the receiving apparatus 3.

The receiving apparatus 3 illustrated in FIG. 7 includes the receiving analyzing unit 31, similarly to the receiving apparatus 3 illustrated in FIG. 4. T he receiving analyzing unit 31 extracts the time-lag information from the received file, and calculates a transmission delay time.

According to the network delay measurement method according to the fourth example embodiment, in operation 100, the detection packet (j) which is to be sent into the network 10 is captured and the send time Sⱼ may be obtained, similarly to the above-described operation 100.

In operation 200, the difference Δj(=Sⱼ−Cⱼ) (the time-lag information) may be calculated using the obtained send time Sⱼ and the creation time Cⱼ which was inserted into the detection packet (j) when the detection packet (j) was created. In operation 300, the time-lag information storing/reading section 27 of the time-lag processing unit 5 stores the obtained difference Δj in a file.

The sending apparatus 2 executes operation 400 at a predetermined time after storing the time-lag information to be sent, as a notification, to the receiving apparatus 3 in the file. In operation 400, the time-lag information storing/reading section 27 reads the file stored in operation 300. In operation 500, the read file may be transmitted to the receiving apparatus.

In operation 600, the receiving analyzing unit 31 of the receiving apparatus 3 extracts the time-lag information (the difference Δj) from the received file, and calculates the transmission delay time using the extracted difference Δj.

Here, in the above described example embodiments, the difference Δj can be obtained as the time-lag information; however, the time-lag information Is not limited thereto. The configuration for the fourth example embodiment may be a configuration in which the send time Sⱼ is stored in the file as the time-lag information.

Moreover, a time interval between the processing of writing the time-lag information into the file (operation 300) and the processing of reading the time-lag information from the file and obtaining the transmission delay time (operation 400) can be set to an arbitrary value.

In addition, the above-described operation only describes the case in which the obtained difference Δj of the detection packet (j) may be stored in the file; however, what is to be stored is not limited thereto.

For example, the configuration for the fourth example embodiment may be a configuration in which, with respect to a plurality of detection packets, differences Δj, Δ(j+1), Δ(j+2), and the like are sequentially obtained and they are collectively stored in a file.

In a case in which such a configuration is employed, the creation time Cⱼ and the send time Sⱼ (or the difference Δj) are stored in the file in a manner such that they are related to information used to identify the detection packet (for example, “packet number j” or the like).

The receiving apparatus 3 can sequentially obtain the transmission delay times of detection packets by referring to pieces of information used to identify the detection packets.

The creation time Cⱼ of the detection packet may be stored in the file and sent as a notification to the receiving apparatus 3 with the time-lag information. As illustrated in FIG. 7, the creation time Cⱼ of the detection packet may be sent by being inserted into the payload of the detection packet to be sent.

As a method of sending the file to the receiving apparatus 3, as illustrated in FIG. 7, the file may be directly sent to the receiving apparatus 3, or may be sent via a file server.

Alternatively, the time-lag information obtained in the sending apparatus 2 or in the time-lag processing apparatus 6 may be stored in a recording medium such as a compact disk (CD) or a digital versatile disk (DVD), and the receiving apparatus 3 may be configured to read the time-lag information from the recording medium.

As described above, according to the network delay measurement method according to an example embodiment, the sending apparatus that sends detection packets obtains the send time of each of the detection packets, and stores the obtained send time or calculated difference (the time-lag information) of the detection packet in the file.

The sending apparatus can read and send the file to the receiving apparatus at a predetermined time. The receiving apparatus reads the time-lag information from the file, and calculates, based on this read time-lag information, the transmission delay time which does not include the in-apparatus delay, that is, the delay occurring in the network.

Accordingly, similarly to the above-described case in which the time-lag information is inserted into the detection packet, the transmission delay time with consideration of the in-apparatus delay, that is, the delay occurring in the network can be more precisely obtained.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A measurement method comprising:
writing a creation time upon a detection packet used for detecting a communication state of a network being created into the detection packet;
obtaining a send time when the detection packet was sent;
sending, to a receiving apparatus which receives the detection packet, as a notification, information regarding a time period from when the detection packet was created to when the detection packet was sent; and
measuring, in the receiving apparatus, a delay occurring in the network based on the detection packet and the information sent as the notification.

2. The measurement method according to claim 1,
wherein the information sent as the notification to the receiving apparatus includes the send time when the detection packet was sent or the difference between the creation time when the detection packet was created and the send time, and
the delay occurring in the network is calculated, using the send time or the difference, by calculating a time period from when the detection packet was sent to when the detection packet was received in the measuring the network delay.

3. The measurement method according to claim 2,
wherein the information sent to the receiving apparatus as the notification is written into a detection packet subsequent to the detection packet.

4. The measurement method according to claim 2,
wherein the information sent to the receiving apparatus as the notification is stored in a file.

5. The measurement method according to claim 3,
wherein, j pieces of information from the n-th detection packet to the n+j−1-th detection packet among pieces of information sent to the receiving apparatus as notifications are written into a detection packet subsequent to the n+j−1-th detection packet in units of k packets, where j represents a positive integer, n represents an integer, and k represents an integer less than or equal to j.

6. The measurement method according to claim 4,
wherein j pieces of information from the n-th detection packet to the n+j−1-th detection packet among pieces of information sent to the receiving apparatus as notifications are written into the file, and
processing of storing information in the file is executed in every k detection packets, where j represents a positive integer, n represents an integer, and k represents an integer less than or equal to j.

7. A communication system comprising:
a creation time insertion unit for writing a creation time when a detection packet used for detecting a communication state of a network was created into the detection packet;
an obtaining unit for obtaining a send time when the detection packet was sent;
a notification unit for sending, to a receiving apparatus of the detection packet, as a notification, information regarding a time period from when the detection packet was created and to when the detection packet was sent; and
a measurement unit for measuring, in the receiving apparatus, a delay occurring in the network based on the detection packet and the information sent as a notification.
